(19) United States
(12) Patent Application Publication
(10) Pub. No.: US 2026/0024262 A1
(43) Pub. Date: Jan. 22, 2026

(54) TECHNIQUES FOR AUTOMATED GENERATION AND RIGGING OF OBJECTS FOR ANIMATION

(71) Applicant: DISNEY ENTERPRISES, INC., Burbank, CA (US)

(72) Inventors: Michael John ILARDI, Los Angeles, CA (US); Prutsdom JIARATHANAKUL, Glendale, CA (US); Samuel Avery LEVIN, Burbank, CA (US); Anjali Utpal THAKRAR, Burbank, CA (US)

(21) Appl. No.: 18/774,813

(22) Filed: Jul. 16, 2024

(51) Int. Cl. G06T 13/40; G06T 5/70; G06T 7/11; G06T 7/13; G06T 7/70; G06T 17/20

(52) U.S. Cl. CPC G06T 13/40; G06T 5/70; G06T 7/11; G06T 7/13; G06T 7/70; G06T 17/20; G06T 2207/20081

(57) ABSTRACT

One embodiment of a method for generating animations includes generating one or more images of an object based on user input, generating textured geometry based on the one or more images, generating a weight map based on at least one image included in the one or more images, and generating an animation of the object based on the textured geometry, the weight map, and a skeleton.

### BACKGROUND

### Technical Field

Embodiments of the present disclosure relate generally to computer animation, machine learning, and artificial intelligence (AI) and, more specifically, to techniques for automated generation and rigging of objects for animation.

### Description of the Related Art

Character animation is the process of creating a series of different poses, expressions, and/or actions of a character that can be played back sequentially. Various approaches have been developed for creating character animations, including drawing animations by hand, stop-motion, and computer-generated animations.

Computer-generated character animations are typically created via a largely manual process where animators use software to design and move three-dimensional (3D) virtual models of characters in ways the characters may move in given animation sequences. The manual creation of character animations requires significant expertise in the software and also is typically very labor intensive and time consuming. Accordingly, more automated techniques have been developed for less experienced users to create character animations.

One approach for creating character animations automatically involves selecting among predefined attributes and clothing to customize a generic character into a customized character. The customized character can then be animated with a set of skeleton joints that are used to deform and move any customized characters created from the generic character. One drawback of this approach is the set of predefined attributes and clothing for a given character is oftentimes limited. The limited set of predefined attributes and clothing restricts artistic creativity in the types of customized characters, and animations involving those characters, that can be created. Another drawback of this approach is the inability to generate animated props that do not fit a standardized silouhette, like a humanoid character might.

Another approach for creating character animations automatically involves drawing a character on a template that defines a layout and proportions for the character. The drawn character can then be animated with a set of skeleton joints for the template that are used to deform and move the character. One drawback of this approach is that the template that defines the layout and proportions of the character is fixed and, therefore, may not be suitable for some of the characters users want to animate. For example, the template could require a character to have arms and legs of certain sizes, whereas a user may want to animate a character that has arms and legs of different sizes or that does not have any arms or legs. Accordingly, use of templates can limit artistic creativity in the types of characters, and animations of those characters, that can be created.

As the foregoing illustrates, what is needed in the art are more versatile techniques for generating animations.

### SUMMARY

One embodiment of the present application sets forth a computer-implemented method for generating animations. The method includes generating one or more images of an object based on user input. The method also includes generating textured geometry based on the one or more images. The method further includes generating a weight map based on at least one image included in the one or more images. In addition, the method includes generating an animation of the object based on the textured geometry, the weight map, and a skeleton.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that, with the disclosed techniques, animations of objects (e.g., characters) having any shapes and proportions can be generated automatically. Further, the disclosed techniques permit the animations of objects to be generated relatively quickly, including under a few seconds. In addition, the disclosed techniques generate animatable assets that can be puppeteered to produce different animations. These technical advantages represent one or more technological improvements over prior art approaches.

### BRIEF DESCRIPTION OF THE DRAWINGS

So that the manner in which the above recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a system configured to implement one or more aspects of the various embodiments;

FIG. 2 is a more detailed illustration of the animation application of FIG. 1, according to various embodiments;

FIG. 3 is a more detailed illustration of the image generation module of FIG. 2, according to various embodiments;

FIG. 4 is a more detailed illustration of the image processing module of FIG. 2, according to various embodiments;

FIG. 5 is a more detailed illustration of the smearing module of FIG. 4, according to various embodiments;

FIG. 6 is a more detailed illustration of the 3D engine of FIG. 2, according to various embodiments;

FIG. 7 sets forth a flow diagram of method steps for generating a character animation, according to various embodiments;

FIG. 8 sets forth a flow diagram of method steps for generating images of a character based on a user input, according to various embodiments;

FIG. 9 sets forth a flow diagram of method steps for determining joint positions and generating a smeared segmentation of a character, according to various embodiments; and

FIG. 10 sets forth a flow diagram of method steps for generating a smeared segmentation of a humanoid character, according to various embodiments.

### DETAILED DESCRIPTION

In the following description, numerous specific details are set forth to provide a more thorough understanding of the present invention. However, it will be apparent to one of skill in the art that embodiments of the present invention may be practiced without one or more of these specific details.

### System Overview

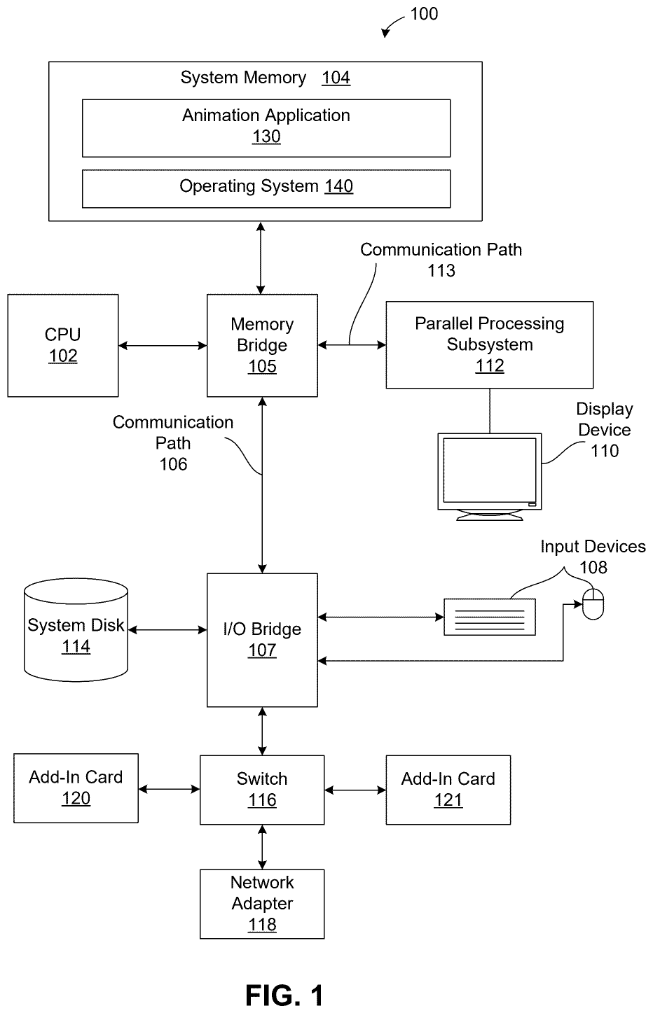

FIG. 1 illustrates a system 100 configured to implement one or more aspects of the various embodiments. As shown, the system 100 includes, without limitation, a central processing unit (CPU) 102 and a system memory 104 coupled to a parallel processing subsystem 112 via a memory bridge 105 and a communication path 113. The memory bridge 105 is further coupled to an I/O (input/output) bridge 107 via a communication path 106, and the I/O bridge 107 is, in turn, coupled to a switch 116.

In operation, the I/O bridge 107 is configured to receive user input information from one or more input devices 108, such as a keyboard, a mouse, a joystick, etc., and forward the input information to the CPU 102 for processing via the communication path 106 and the memory bridge 105. The switch 116 is configured to provide connections between the I/O bridge 107 and other components of the system 100, such as a network adapter 118 and various add-in cards 120 and 121. Although two add-in cards 120 and 121 are illustrated, in some embodiments, the system 100 may only include a single add-in card.

As also shown, the I/O bridge 107 is coupled to a system disk 114 that may be configured to store content, applications, and data for use by CPU 102 and parallel processing subsystem 112. As a general matter, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, movie recording devices, and the like, may be connected to the I/O bridge 107 as well.

In various embodiments, the memory bridge 105 may be a Northbridge chip, and the I/O bridge 107 may be a Southbridge chip. In addition, communication paths 106 and 113, as well as other communication paths within the system 100, may be implemented using any technically suitable protocols, including, without limitation, AGP (Accelerated Graphics Port), HyperTransport, or any other bus or point-to-point communication protocol known in the art.

In some embodiments, the parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs) included within the parallel processing subsystem 112. In other embodiments, the parallel processing subsystem 112 incorporates circuitry optimized for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and compute processing operations. The system memory 104 may include at least one device driver configured to manage the processing operations of the one or more PPUs within the parallel processing subsystem 112.

In various embodiments, the parallel processing subsystem 112 may be or include a graphics processing unit (GPU). In some embodiments, the parallel processing subsystem 112 may be integrated with one or more of the other elements of FIG. 1 to form a single system. For example, the parallel processing subsystem 112 may be integrated with the CPU 102 and other connection circuitry on a single chip to form a system on chip (SoC).

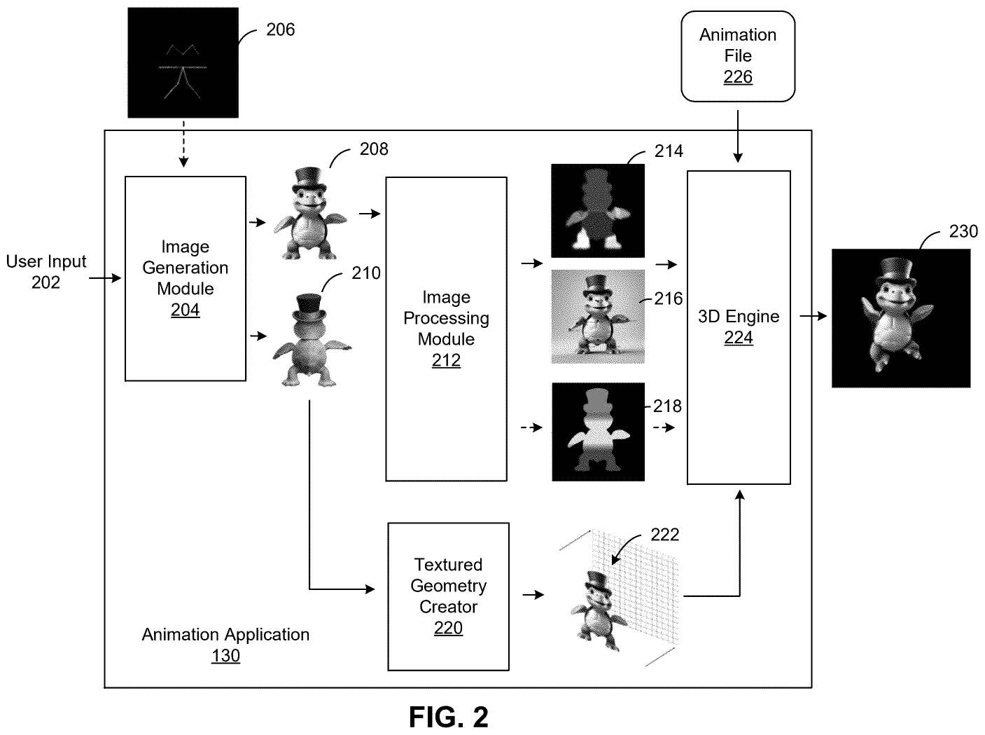

Illustratively, the system memory 104 stores an animation application 130 and an operating system 140 on which the animation application 130 runs. The operating system 140 may be, e.g., Linux®, Microsoft Windows®, or macOS®. The animation application 130 is a software application that is configured to automatically generate animations based on user input, as discussed in greater detail below in conjunction with FIGS. 2-10.

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, the system memory 104 could be connected to the CPU 102 directly rather than through the memory bridge 105, and other devices would communicate with the system memory 104 via the memory bridge 105 and the CPU 102. In other alternative topologies, the parallel processing subsystem 112 may be connected to the I/O bridge 107 or directly to the CPU 102, rather than to the memory bridge 105. In still other embodiments, the I/O bridge 107 and the memory bridge 105 may be integrated into a single chip instead of existing as one or more discrete devices. In some embodiments, any combination of the CPU 102, the parallel processing subsystem 112, and the system memory 104 may be replaced with any type of virtual computing system, distributed computing system, or cloud computing environment, such as a public cloud, a private cloud, or a hybrid cloud. Further, in certain embodiments, one or more components shown in FIG. 1 may not be present. For example, the switch 116 could be eliminated, and the network adapter 118 and add-in cards 120, 121 would connect directly to the I/O bridge 107. Lastly, in certain embodiments, one or more components shown in FIG. 1 may be implemented as virtualized resources in a virtual computing environment, such as a cloud computing environment.

### Automatically Generating and Rigging Objects for Animation

FIG. 2 is a more detailed illustration of the animation application 130 of FIG. 1, according to various embodiments. As shown, the animation application 130 includes an image generation module 204, an image processing module 212, a textured geometry creator module 220 (also referred to herein as “textured geometry creator 220”), and a three-dimensional (3D) engine 224. In operation, the animation application 130 receives a user input 202, an animation file 226, and optionally a skeleton pose 206 as inputs. Given such inputs, the animation application 130 generates an animation 230 as output.

Any technically feasible user input 202 can be received in some embodiments. In some embodiments, the user input can include natural language text describing a character, such as “a turtle wearing a top hat.” Although described herein primarily with respect to characters as a reference example, in some embodiments, techniques disclosed herein can be used to generate animations of any objects, such as props, vehicles, etc. that are described in user input. In some embodiments, in addition to or in lieu of text, the user input 202 can include an image of a character (or object), such as a sketch or other image that is provided by a user.

The optional skeleton pose 206 is a skeleton, which can include a number of joints and bones between the joints, that has been posed in a desired pose for a character. For example, the skeleton pose 206 could be a T-posed skeleton that is used to constrain images generated by the image generation module 204. Although a single skeleton pose 206 is shown for illustrative purposes, in some embodiments, any number of skeleton poses, including zero skeleton poses, can be used. In some embodiments, the animation application 130 can process the user input 202 using a natural language classifier model or a language model (e.g., a large language model) that outputs a type of character (or other object) specified by text in the user input 202. In such cases, the animation application 130 can use a skeleton pose that is relevant to the type of character (or other object) to constrain images generated by the image generation module 204. For example, the skeleton pose that is used could be different for humanoid and non-humanoid characters. In some embodiments, the same skeleton pose can be used to constrain images generated by the image generation module 204 for all user inputs. For example, a humanoid skeleton pose could be used to constrain images of all types of characters (or other objects) that are generated by the image generation module 204 to appear humanoid. In some embodiments, a user can input a hand-drawn or otherwise manually created skeleton that the animation application 130 converts to a skeleton pose in a particular format, and the animation application 130 can use such a skeleton pose to constrain images generated by the image generation module 204.

As shown, the image generation module 204 processes the user input 202 and optionally the skeleton pose 206 to generate an image 208 of a front of a character corresponding to the user input “a turtle wearing a top hat,” as well as an image 210 of a back of the character. Although two images 208 and 210 are shown for illustrative purposes, in some embodiments, any number of images of a character, from any number of viewpoints, can be generated for the user input 202 and optionally the skeleton pose 206.

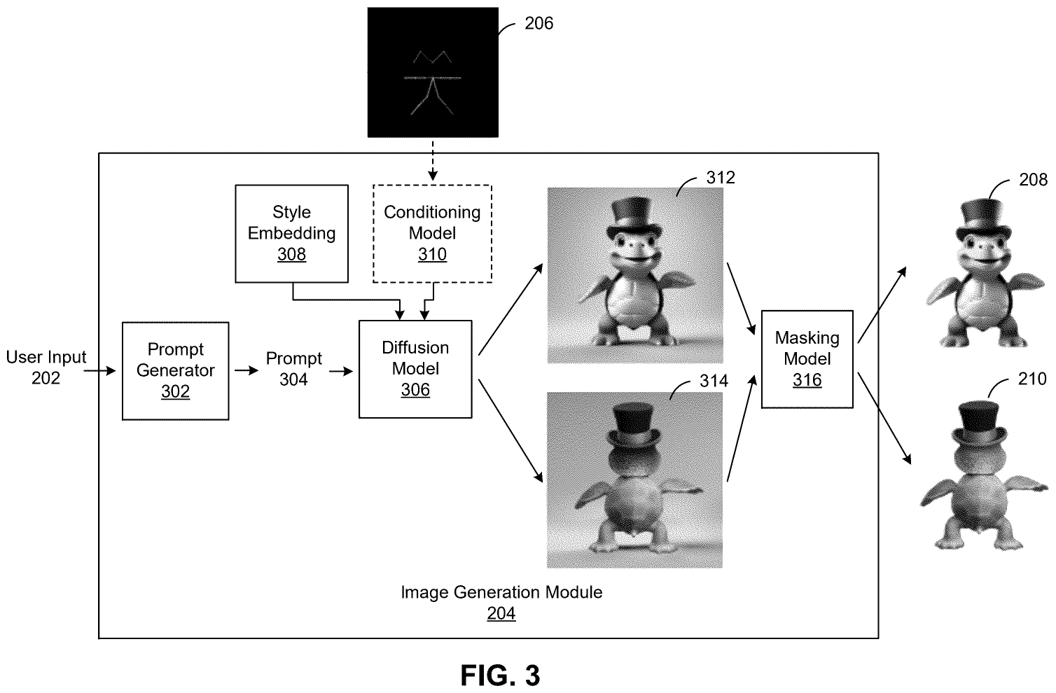

FIG. 3 is a more detailed illustration of the image generation module 204 of FIG. 2, according to various embodiments. As shown, the image generation module 204 includes a prompt generator module 302 (also referred to herein as “prompt generator 302”), a text-to-image diffusion model 306 (also referred to herein as “diffusion model 306”), a style embedding 308, an optional conditioning model 310, and a masking model 316. Although described herein primarily with respect to the animation application 130 and modules thereof including various models for simplicity, in some embodiments, one or more models can execute elsewhere (e.g., in a cloud computing environment) and be accessed by the animation application 130 via, e.g., one or more application programming interfaces (APIs). In operation, the prompt generator 302 generates, from text in the user input 202, a prompt 304 that is input into the diffusion model 306. Any suitable prompt or prompts can be generated in some embodiments, depending on the images to be generated. For example, in some embodiments, the user input 202 can include text that is directly input into the diffusion model 306, without modification. As another example, in some embodiments, the prompt generator 302 can modify text in the user input 202 to generate a prompt that includes text specifying additional characteristics the generated images should include. Although described herein primarily with respect to generating a prompt as a reference example, in some embodiments, a diffusion model or another image-generating technique can be controlled to generate images based on user input in any technically feasible manner. For example, in some embodiments in which the user input includes a hand-drawn sketch of a character, a conditioning model such as ControlNet can be used along with a prompt to control a diffusion model to generate an image of a character that is similar to the character in the hand-drawn sketch. As another example, in some embodiments, an image-to-image technique, such as an image-to-image diffusion model, can be applied to transform a hand-drawn sketch of a character into an image of a character that is similar to the character in the hand-drawn sketch.

The diffusion model 306 performs a denoising diffusion technique that begins from a noisy image and iteratively applies a learned transformation in reverse to obtain denoised images, until a final image is generated. Although described herein primarily with respect to the diffusion model 306 as a reference example, images can be generated from user input in any technically feasible manner, including using other types of machine learning models, in some embodiments. To generate an image 208 of the front a character, the denoising diffusion technique performed by the diffusion model 306 is conditioned on the prompt 304 that is input into the diffusion model 306, as well as a style embedding 308 and optionally the skeleton pose 206. The style embedding 308 and the conditioning model 310 are used to control an artistic style of the image generated by the diffusion model 306 and a pose of the character in the image 208 to match the skeleton pose 206, respectively. For example, the style embedding 308 could be associated with a cartoonish style, a photorealistic style, or any other desired style, to control the diffusion model 306 to generate stylized images having such a style. Using the style embedding 308 and the conditioning model 310, the diffusion model 306 can be controlled to generate output images that include a consistent style and characters with poses that are animatable.

In some embodiments, the style embedding 308 can be implemented using low-rank adaptation (LoRA), in which the diffusion model 306 is fine tuned by adding low-rank matrices to existing weights of the diffusion model 306 and training the low-rank matrices using images having the desired style (e.g., cartoonish, photorealistic, etc.). In some embodiments, in addition to or in lieu of the style embedding 308, the prompt generator 302 can generate a prompt for input into the diffusion model 306 that indicates a desired style of the image to be generated. For example, to indicate a photorealistic style, the prompt generator 302 could insert the user input “a turtle wearing a top hat” into a prompt template indicating the photorealistic style to generate the prompt “photograph of a turtle wearing a top hat, like stock image with plain background.” In some other embodiments, an artistic style of images that are generated by the diffusion model 306 can be controlled in any technically feasible manner, such as using inversion-based style transfer, DreamBooth, etc.

In some embodiments, the conditioning model 310 can be a machine learning model, such as ControlNet, that controls the diffusion model 306 by conditioning the diffusion model 306 with an input image that includes the skeleton pose 206. Using the conditioning model 310, the diffusion model 306 can be constrained to generate images, such as the images 312 and 314, of characters having the skeleton pose 206.

In some embodiments, the configuration of the image generation process, such as conditioning model(s) (e.g., the conditioning model 310) and/or embedding(s) (e.g., the style embedding 308) that are used to configure the diffusion model 306, are known beforehand, permitting the diffusion model 306 to be pre-compiled in a manner that is optimized for the known configuration. Experience has shown that such a pre-compiled diffusion model 306 can execute faster than a conventional diffusion model. In addition, the animation application 130 can execute relatively quickly by generating and processing 2D images, until a 2.5D or 3D animatable asset is created and animated. For example, experience has shown that the execution time from when the animation application 130 receives a user input in the form of text describing a character to when the animation application 130 generates an animation of a 2.5D character can be less than 1.5 seconds.

To generate the image 314 of the back of the character, the diffusion model 306 performs a denoising diffusion technique conditioned on a modification of the prompt 304, as well as the style embedding 308 and a mirror image of the image 312 of the front of the character. For example, the modification of the prompt 304 could specify “back of a turtle wearing a top hat” rather than “a turtle wearing a top hat.” Similar to the skeleton pose 206, the diffusion model 306 can be conditioned on the mirror image of the image 312 of the front of the character using a conditioning model, such as ControlNet, so that a shape of the back of the character matches a shape of the front of the character. As discussed in greater detail below, images of the front and back of a character can be used to create a 2.5D animatable asset, which can be a fully rigged 2.5D character that includes a front and a back and is deformable in 3D space. Although the diffusion model 306 is shown as generating the images 312 and 314 of the front and back of the character for illustrative purposes, in some embodiments, any number of images can be generated using a trained machine learning model or any other technically feasible image-generating techniques. For example, in some embodiments, multiple images can be generated from different viewpoints for use in generating 3D geometry (e.g., a mesh) for a character via an image-to-3D reconstruction model.

The image generation module 204 inputs images of the character (e.g., images 312 and 314) generated by the diffusion model 306 into a masking model 316 that removes the background from such images. The masking model 316 is a machine learning model that has been trained to remove backgrounds from images. For example, in some embodiments, the masking model 316 can be a U2-Net model. Illustratively, backgrounds from the images 312 and 314 are removed to generate images 208 and 210, respectively. In some other embodiments, the diffusion model 306 can directly generate images of the alpha channel, in which the background is removed.

Returning to FIG. 2, after the image generation module 204 generates images of a character (e.g., images 208 and 210) based on user input (e.g., user input 202) and optionally a skeleton pose (e.g., skeleton pose 206), the textured geometry creator 220 processes the generated images to generate textured geometry, shown as textured geometry 222. In some embodiments, the textured geometry creator 220 can apply the generated images to planar mesh geometry to generate textured geometry, which can then be animated as a 2.5D character that can deform and move in 3D space according to an animation. In some other embodiments, the textured geometry creator 220 can generate a 3D textured geometry by, for example, using an image-to-3D reconstruction model to generate 3D geometry (e.g., a mesh) from the images and projecting the images onto the 3D geometry via orthographic projection.

In parallel with the textured geometry creator 220 generating the textured geometry 222, the image processing module 212 processes at least one of the images generated by the image generation module 204 to generate a smeared segmented image for a humanoid character 214 (also referred to herein as “smeared segmentation 214”) and an estimated pose of the humanoid character 216 or, alternatively, a smeared segmented image for a non-humanoid character 218 (also referred to herein as “smeared segmentation 218”).

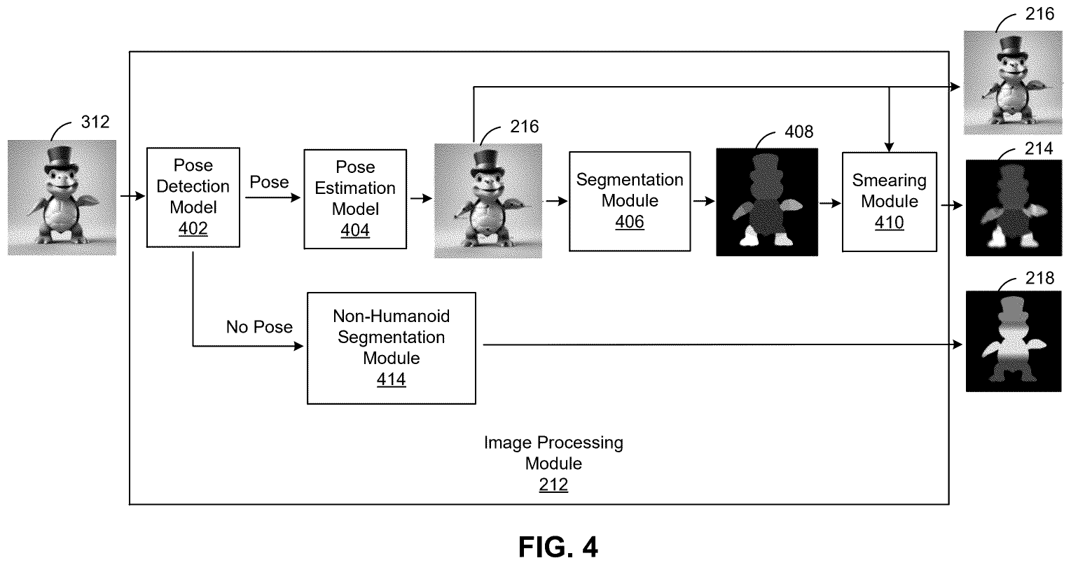

FIG. 4 is a more detailed illustration of the image processing module 212 of FIG. 2, according to various embodiments. As shown, the image processing module 212 includes a pose detection model 402, a pose estimation model 404, a segmentation module 406, a smearing module 410, and a non-humanoid segmentation module 414. In operation, the image processing module 212 inputs an image, shown as the image 314, that is generated by the image generation module 204 into the pose detection model 402. Although the image 314 is shown as being input for illustrative purposes, in some embodiments, the image 208 or another image can be input into the image processing module 212. The pose detection model 402 is a machine learning model that has been trained to detect poses of humanoid characters in input images. In some embodiments, the pose detection model 402 can be specifically trained to detect poses of characters of a certain artistic style, such as cartoonish characters having non-photorealistic renderings and non-human proportions, that are included in images generated by the image generation module 204.

If the pose detection model 402 detects a pose in the image 314, then the image 314 is determined to include a humanoid character. Although described herein primarily with respect to using the pose detection model 402, in some embodiments, whether an image includes a humanoid character can be determined in any technically feasible manner. For example, in some embodiments, the natural language classifier model or language model, described above in conjunction with FIG. 2, can be used to classify text included in the user input 202 as specifying a humanoid character or a non-humanoid character (or a specific type of non-humanoid object). When the image 314 includes a humanoid character, the segmentation module further inputs the image 314 into the pose estimation model 404 to estimate a pose of the character, shown as an image that indicates the pose 216. The pose estimation model 404 is a machine learning model that has been trained to generate poses for humanoid characters in input images. In some embodiments, the generated pose can include key points corresponding to joints of the humanoid characters in the input images. Similarly, in some embodiments in which 3D geometry is generated from images as described above in conjunction with FIGS. 2-3, a trained machine learning model or any other technically feasible technique can be applied to one or more of the images and/or the 3D geometry to generate a 3D pose.

The segmentation module 406 processes the image indicating the pose 216 to generate a segmentation 408. The segmentation 408 is a segmented image indicating body parts such as a head, torso, hand, forearms, etc. that pixels of the input image 312 belong to. In some embodiments, the segmentation module 406 performs a watershed segmentation technique, using joints of the pose as the center of each watershed, to generate the segmentation 408. In the watershed segmentation technique, the image 312 can be flooded from the given joint positions, resulting in an image in which the watershed basins become segments of different body parts of the character. Similarly, in some embodiments in which 3D geometry is generated for images as described above in conjunction with FIGS. 2-3, segmentation can be performed by picking one image used to generate the 3D geometry that is the orthographic front view of the 3D geometry, and processing that image using the segmentation module 406 and the smearing module 410, with the output being applied using orthographic projection to assign skin weights to the 3D geometry. Any other technically feasible segmentation technique can be performed to generate the segmentation 408 in some other embodiments.

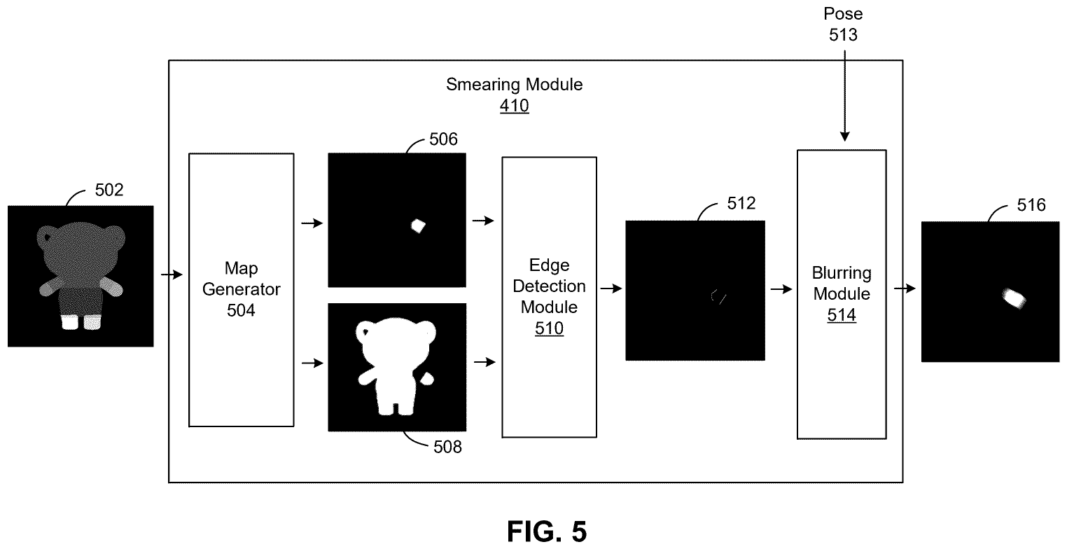

The smearing module 410 processes the segmentation 408 to generate the smeared segmentation 214. The smeared segmentation 214 is an image whose pixel values indicate weights for binding the character in the input image 312 to a skeleton (not shown) that includes the joints detected by the pose estimation model 404. That is, the smeared segmentation 214 can be a smooth blended weight map of where each pixel of the character in the image 312 binds to which joint in the skeleton. In some embodiments, such a weight map can be used to bind each vertex of a textured mesh in which the image 312 is applied to planar mesh geometry (e.g., a square mesh) to the skeleton. The smearing module 410 is discussed in greater detail below in conjunction with FIG. 5. Alternatively, if the pose detection model 402 does not detect a humanoid pose of the character in the image 312, then the non-humanoid segmentation module 414 processes the input image 312 to generate the smeared segmentation for a non-humanoid character 218. The smeared segmentation 218 is an image whose pixel values indicate weights for binding a non-humanoid character to a skeleton (not shown). In some embodiments, to generate the smeared segmentation 218, the non-humanoid segmentation module 414 can determine a primary axis of the character in the input image 312, segment the character in the input image 312 into a number of segments (shown as three segments) along the primary axis, and smear edges of the segments along the primary axis.

FIG. 5 is a more detailed illustration of the smearing module 410 of FIG. 4, according to various embodiments. As shown, the smearing module 410 includes a map generator module 504 (also referred to herein as “map generator 504”), an edge detection module 510, and a blurring module 514. After the smearing module 410 receives a segmentation, shown as segmentation 502, of a character in an image, the smearing module 410 processes each body segment in the segmentation 502 to generate a corresponding smeared segmentation. In some embodiments, the processing includes the following operations that can be executed on a GPU for parallel computation that is relatively fast. First, the map generator 504 generates a map for a body segment, shown as a map 506 for an upper left arm of the character, and a map for a remaining body of the character, shown as a map 508. In some embodiments in which the segmentation 502 uses different colors to represent different body segments, the map generator 504 can isolate each body segment by color and convert the colored body segment to a mono texture (e.g., a 32 bit, mono texture), such as the map 506 for the upper left arm. In such cases, the map generator 504 can also compute the overall body of the character by converting the segmented image 502 into a mono texture (e.g., a 32 bit, mono texture). To generate the map 508 for the remaining body of the character, the map generator 504 subtracts the mono texture of the upper left arm from the mono texture of the overall body.

After generating the map for the body segment 506 and the map for the remaining body of the character 508, the edge detection module 510 determines edges 512 of the body segment based on the maps 506 and 508. In some embodiments, the edge detection module 510 can use any technically feasible edge detection technique to detect edges in the maps 506 and 508 that represent the boundary between the body segment and the remaining body of the character. For example, in some embodiments, the edge detection module 510 can expand, by several pixels, both the isolated body segment in the map 506 and the remaining body of the character in the map 508. Then, the expanded body segment and the expanded remaining body can be subtracted from each other to find overlapping portions that indicate the edges of the body segment representing the boundary between the body segment and the remaining body of the character.

The blurring module 514 computes the angle of a bone associated with the body segment based on joints associated with the body segment in an estimated pose 513 determined by the pose estimation model 404. The bone can be imagined to connect an upper joint associated with the body segment with a parent joint of the upper joint. In the case of the upper left arm, the upper joint is the left elbow joint, the parent joint is the left shoulder joint, and the bone associated with the upper left arm runs through the left elbow joint and the left shoulder joint.

The blurring module 514 applies a directional blur along the edges of the body segment (e.g., the overlaps described above) that are determined by the edge detection module 510 in a direction of the angle of the bone to generate a blur map (not shown). In addition, the blurring module 514 normalizes the blur map to, e.g., 0-1, and adds the map 506 for the isolated body segment to the blur map to generate a weight map 516 for the body segment. The weight map 516 is a texture map that represents the isolated body segment “smeared” along the axis of the bone that runs through the body segment. In some embodiments, values in the weight map 516 that are outside of 0-1 are clamped to 0 and 1.

The foregoing process can be repeated to generate a weight map for each body segment in the segmentation 502. Together, the weight maps for the different body segments form a smeared segmentation of the character, such as the smeared segmentation 214 described above in conjunction with FIGS. 2 and 4.

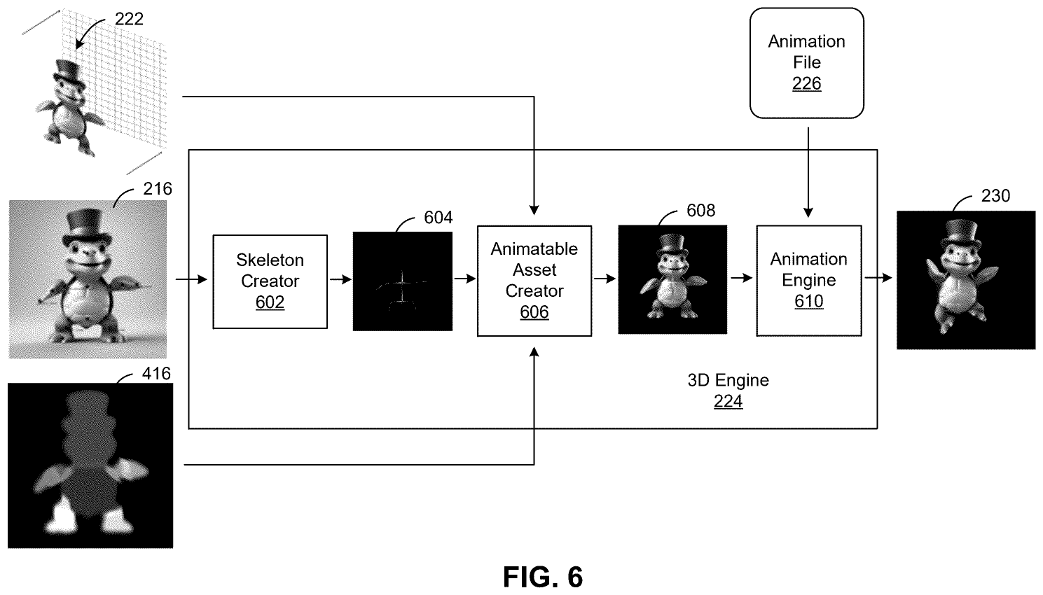

Returning to FIG. 2, the 3D engine 224 processes the smeared segmentation 214 or the smeared segmentation 218, joints of the estimated pose 216 (for the smeared segmentation 214) or a predefined skeleton (for the smeared segmentation 218), the textured geometry 222, and the animation file 226 to generate the character animation 230. FIG. 6 is a more detailed illustration of the 3D engine 224 of FIG. 2, according to various embodiments. As shown, the 3D engine 224 includes a skeleton creator module 602 (also referred to herein as “skeleton creator 602”), an animatable asset creator module 606 (also referred to herein as “animatable asset creator 606”), and an animation engine 610. In operation, the skeleton creator 602 connects joints determined by the pose estimation model 404, which can be labeled as joints for different body parts (e.g., head, shoulder, elbow, wrist, etc. joints), together to form a skeleton 604 that includes the joints and bones connecting the joints. For humanoid characters, the animatable asset creator 606 binds the textured geometry 222 to the skeleton 604, using the smeared segmentation 218 as a weight map to weight the binding, to generate an animatable asset 608. For non-humanoid characters, the animatable asset creator 606 can generate the animatable asset 608 by binding the textured geometry 222 to a predefined skeleton using the smeared segmentation 218 as a weight map. For example, in some embodiments, the predefined skeleton can be a linear skeleton that includes a chain of joints along a primary axis, with each joint bound to each segment of the smeared segmentation 218. In such cases, the animatable asset generated using the linear skeleton can be animated to move in 3D space according to any suitable animation, such as wiggling, jumping up and down, squashing and stretching, etc., thereby applying anthropomorphic animations to non-humanoid characters that cannot be fitted with a humanoid skeleton. Accordingly, rigging and skinning of humanoid and non-humanoid characters, which are traditionally performed manually, can be automated by the animation application 130. Although described herein primarily with respect to a single animation for illustrative purposes, in some embodiments, any number of animations can be applied, such as a predefined series of animations, multiple animations that a user is allowed to select among and/or switch between, etc.

The animation engine 610 can generate an animation 230 of the animatable asset based on the animation file 226 that specifies an animation as movements of joints of the skeleton 604. That is, an animation specified in the animation file 226 (or elsewhere) can be imported and played onto the animatable asset to animate the animatable asset within a 3D space, thereby generating the animation 230 of the animatable asset deforming and/or moving according to the animation file 226. The animation 230 can also be rendered to multiple frames of a video, which can then be displayed via a display device. More generally, animatable assets and/or animations thereof that are generated according to techniques disclosed herein can be used in any technically feasible manner. For example, in some embodiments, an animation of an animatable asset can be used within a video game or an extended reality (XR) environment, such as a virtual reality (VR), augmented reality (AR), or mixed reality (MR) environment. As another example, in some embodiments, an animatable asset or animation thereof can be stored and imported for use in another application.

In some embodiments, to improve the computational efficiency of generating an animation, the animation engine 610 can store weight map data (e.g., from the smeared segmentation 214 or the smeared segmentation 218) as texture data that can be directly loaded onto a GPU, and then convert the texture data to vertex data. Typically in skeletal animation, a character model is prepared with the associated bone data already stored on a mesh of the character model. However, generating such a character model on the fly and importing the character model into a 3D scene in real-time can be problematic, because loading a new mesh is computationally intensive for a CPU and can cause the frame rate to stutter. In some embodiments, the same planar mesh is used for every 2.5D character, and bone data is loaded separately as textures. Loading textures into a 3D scene is not computationally intensive as textures can be loaded directly onto the GPU, bypassing the CPU. In such cases, two textures can be created, one for bone indices and one for bone weights. The textures can have the same dimensions in pixels as the dimensions of the vertices of the planar mesh. Further, the textures can be in the RGBA (red, green, blue, alpha) format with 4 channels to hold data for 4 bones per vertex. From the weight map, the data for the top 4 bones affecting each vertex can be extracted and stored onto each pixel in the textures. In a 3D scene, the two textures can be loaded directly into a custom shader that reads the vertex indices and vertex weights from the two textures respectively and computes a blended final vertex position for an animation.

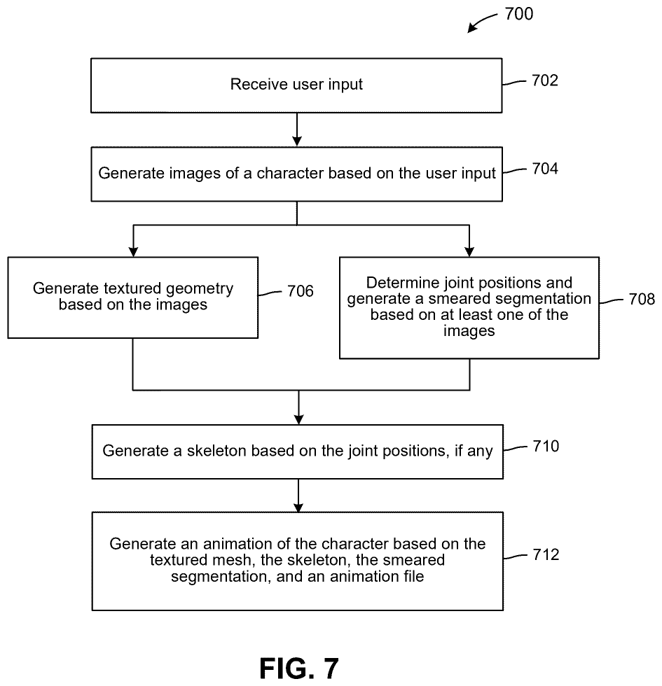

FIG. 7 sets forth a flow diagram of method steps for generating a character animation, according to various embodiments. Although the method steps are described in conjunction with the system of FIGS. 1-6, persons of ordinary skill in the art will understand that any system configured to perform the method steps, in any order, is within the scope of the present disclosure.

As shown, a method 700 begins at step 702, where the animation application 130 receives a user input. Any suitable user input can be received in some embodiments. For example, the user input can include natural language text describing a character, an image of a character, and/or the like.

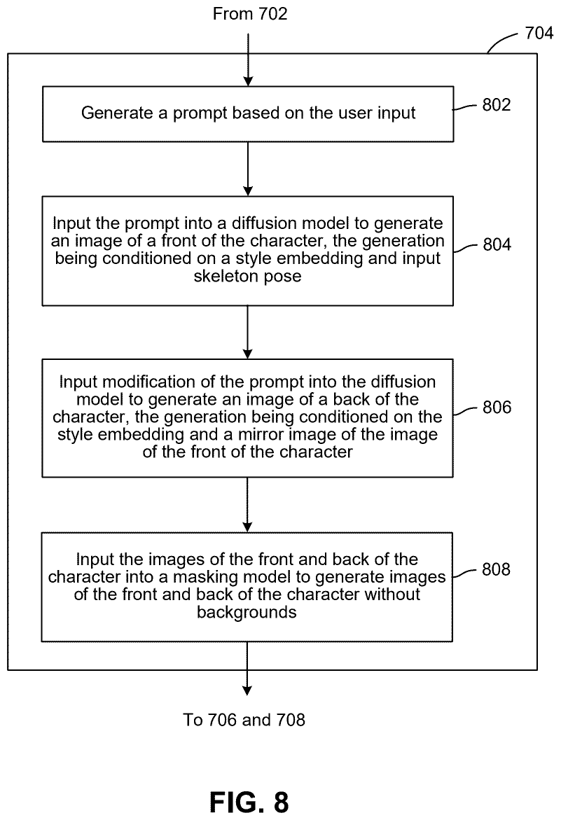

At step 704, the animation application 130 generates images of a character based on the user input. In some embodiments, when the user input includes text describing a character to be created in 2.5D, the animation application 130 can generate a prompt based on the text; input the prompt into a diffusion model to generate an image of a front of the character, the generation being conditioned on a style embedding and optionally an input skeleton pose; input a modification of the prompt into the diffusion model to generate an image of a back of the character, the generation being conditioned on the style embedding and the image of the front of the character; and input the front and back images of the character into a masking model to generate front and back images of the character without a background, as discussed in greater detail below in conjunction with FIG. 8. More generally, in some embodiments, any number of images can be generated for any suitable user input. For example, when the user input includes an image of a character, such as a sketch or other image that is provided by a user, the generation of the image of the front of the character, described above, can also be conditioned on the image that is received as user input. As another example, for a 3D character, the animation application 130 can use a diffusion model to generate multiple images of the character from different viewpoints, which can be input into an image-to-3D reconstruction model to generate 3D geometry for the character.

At step 706, the animation application 130 generates textured geometry based on the images. In some embodiments, for a 2.5D character, the animation application 130 can apply the front and back images of the character, described above in conjunction with step 704, to different sides of a planar mesh geometry, such as a square mesh, to generate textured geometry. In such cases, the front and back images of the character can be applied to different sides of the planar mesh geometry. In some embodiments, for a 3D character, the animation application 130 can use an image-to-3D reconstruction model to generate 3D geometry (e.g., a mesh) from the images, and then orthographically project the images onto the 3D geometry to generate textured geometry.

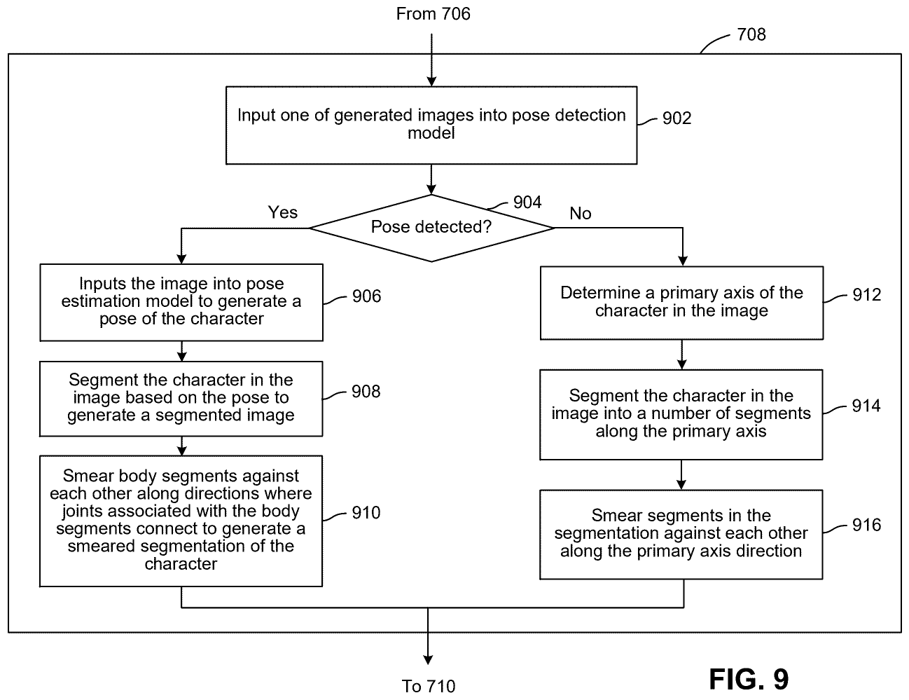

At step 708, the animation application 130 determines joint positions and generates a smeared segmentation of the character based on at least one of the images. As discussed in greater detail below in conjunction with FIG. 9, in some embodiments for a 2.5D character, the animation application 130 can input one of the generated images into the pose detection model 402 to determine whether the image includes a pose of a humanoid character. If a pose is detected, then the animation application 130 can input the image and the pose into the pose estimation model 404 to estimate the pose, input the image and the pose into the segmentation model 406 to generate a segmentation of the character, and smear body segments in the segmentation against each other along directions where joints associated with the body segments connect to generate a smeared segmentation of the character. If no pose is detected, then the animation application 130 can determine a primary axis of the character in the image, segment the character in the image into a number of segments along the primary axis, and smear segments in the segmentation of the character against each other along the primary axis direction.

At step 710, the animation application 130 generates a skeleton based on the joint positions, if any. In some embodiments, the animation application 130 connects the joint positions, determined at step 708, together to form a skeleton that includes the joints and bones connecting the joints. In some embodiments, when no joint positions are determined at step 710 because the character is non-humanoid, then the animation application 130 can use a predefined skeleton, such as a linear skeleton that includes a chain of joints along a primary axis, with each joint bound to each segment of the smeared segmentation of the non-humanoid character.

At step 712, the animation application 130 generates an animation of the character based on the textured geometry, the skeleton, the smeared segmentation, and an animation file. In some embodiments, the animation application 130 binds the textured geometry to the skeleton, using the smeared segmentation as a weight map to weight the binding, to generate an animatable asset. Then, the animation application 130 generates the animation of the animatable asset deforming and/or moving in a 3D space according to an animation specified in the animation file, which can include movements of joints of the skeleton.

FIG. 8 sets forth a flow diagram of method steps for generating images of a character based on a user input at step 704 of the method 700, according to various embodiments. Although the method steps are described in conjunction with the system of FIGS. 1-6, persons of ordinary skill in the art will understand that any system configured to perform the method steps, in any order, is within the scope of the present disclosure.

As shown, at step 802, the animation application 130 generates a prompt based on the user input. Any suitable prompt can be generated in some embodiments. For example, in some embodiments, the prompt can include only text from the user input, without modification. As another example, in some embodiments, the prompt can include text from the user input and text specifying additional characteristics a generated image should include. For example, the animation application 130 could generate the prompt by inserting the text from the user input into a prompt template that includes the additional characteristics.

At step 804, the animation application 130 inputs the prompt into a diffusion model to generate an image of a front of the character, the generation being conditioned on a style embedding and optionally an input skeleton pose. The style embedding and the optional skeleton pose are used to control the artistic style and the pose of the character, respectively, in the image generated by the diffusion model. In some embodiments, the style embedding can be implemented using LoRA, as described above in conjunction with FIG. 3. In some other embodiments, an artistic style of the image generated by the diffusion model can be controlled in any technically feasible manner, such as using inversion-based style transfer, DreamBooth, a prompt that indicates a desired style, etc. In some embodiments, the diffusion model can be conditioned on the optional skeleton pose using a conditioning model, such as ControlNet.

At step 806, the animation application 130 inputs a modification of the prompt into the diffusion model to generate an image of a back of the character, the generation being conditioned on the style embedding and a mirror of the image of the front of the character generated at step 804. In some embodiments, the modification of the prompt can specify that the image to be generated is a back of the character. In some embodiments, the diffusion model can be conditioned on the mirror of the image of the front of the character using a conditioning model, such as ControlNet.

At step 808, the animation application 130 inputs the images of the front and back of the character into a masking model to generate images of the front and back of the character without backgrounds. The masking model 316 is a machine learning model, such as the U2-Net model, that has been trained to remove backgrounds from images.

FIG. 9 sets forth a flow diagram of method steps for determining joint positions and generating a smeared segmentation of a character at step 708 of the method 700, according to various embodiments. Although the method steps are described in conjunction with the system of FIGS. 1-6, persons of ordinary skill in the art will understand that any system configured to perform the method steps, in any order, is within the scope of the present disclosure.

As shown, at step 902, the animation application 130 inputs one of the images generated at step 704 into the pose detection model 402, which has been trained to detect poses of humanoids in input images. Given such input, the pose detection model 402 outputs whether a pose of a humanoid is detected or not.

At step 904, if a pose of the character is detected, then the method 700 continues to step 906, where the animation application 130 inputs the image into the pose estimation model 404 to generate a pose of the character. Given the image as input, the pose estimation model 404 outputs a pose that can include key points corresponding to joints of a character in the image, and each key point can also be labeled (e.g., as a head, elbow, wrist, etc. joint).

At step 908, the animation application 130 segments the character in the image based on the pose to generate a segmented image. In some embodiments, the animation application 130 can perform a watershed segmentation technique, using joints of the pose as the center of each watershed, to generate the segmented image, as described above in conjunction with FIG. 4.

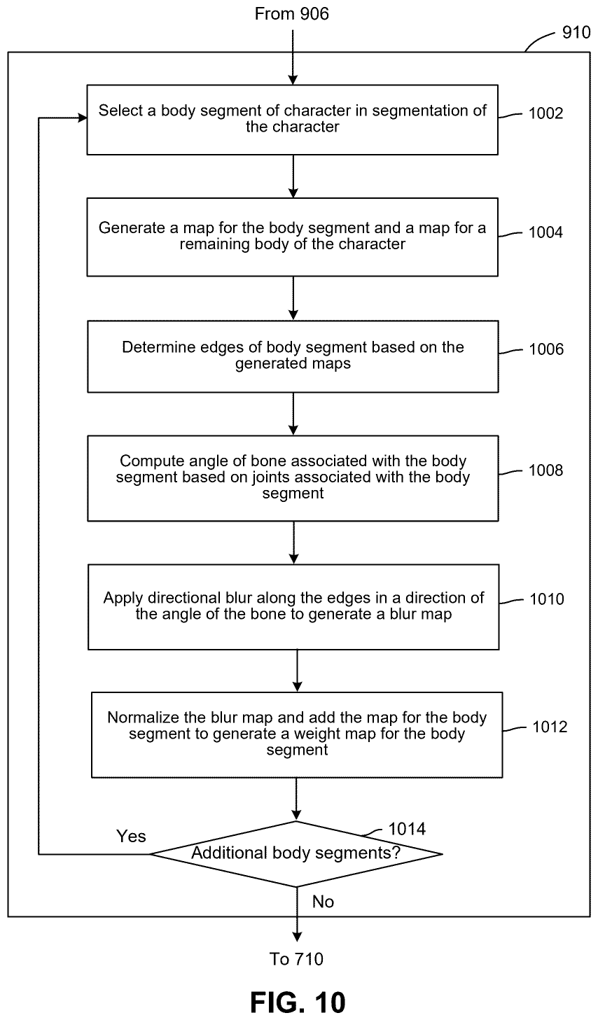

At step 910, the animation application 130 smears body segments in the segmented image against each other along directions where joints associated with the body segments connect to generate a smeared segmentation of the character. In some embodiments, the animation application 130 can smear each body segment by generating a map for the body segment and a map for a remaining body of the character, determining edges of the body segment based on the maps, computing the angle of a bone associated with the body segment based on joints associated with the body segment, applying a directional blur along the edges in a direction of the angle of the bone to generate a blur map, and normalizing the blur map and adding the map for the body segment to the blur map to generate a weight map for the body segment, as discussed in greater detail below in conjunction with FIG. 10.

On the other hand, if a pose of the character is not detected at step 904, then at step 912, the animation application 130 determines a primary axis of the character in the image. The primary axis is a longest axis of the character in the image.

At step 914, the animation application 130 segments the character in the image into a number of segments along the primary axis. In some embodiments, the animation application 130 can segment the character into a predefined number of segments (e.g., 3 segments).

At step 916, the animation application 130 smears segments in the segmentation of the character against each other along the primary axis direction to generate a smeared segmentation of the character.

FIG. 10 sets forth a flow diagram of method steps for generating a smeared segmentation of a humanoid character at step 910, according to various embodiments. Although the method steps are described in conjunction with the system of FIGS. 1-6, persons of ordinary skill in the art will understand that any system configured to perform the method steps, in any order, is within the scope of the present disclosure.

As shown, at step 1002, the animation application 130 selects a body segment of a character in a segmented image of the character. In some embodiments, the segmented image can be generated according to step 906, described above in conjunction with FIG. 9.

At step 1004, the animation application 130 generates a map for the body segment and a map for a remaining body of the character. In some embodiments in which the segmented image uses different colors to represent different body segments, the animation application 130 can isolate each body segment by color and convert the colored body segment to a mono texture (e.g., a 32 bit, mono texture) to generate a map for the body segment. In addition, the animation application 130 can compute the overall body of the character by converting the segmented image into a mono texture. To generate the map for the remaining body of the character, the animation application 130 can subtract the mono texture of the body segment from the mono texture of the overall body.

At step 1006, the animation application 130 determines edges of the body segment based on the maps generated at step 1004. Any technically feasible edge detection technique can be employed in some embodiments. In some embodiments, the animation application 130 can expand, by several pixels, both the isolated body segment in the map for the body segment and the remaining body of the character in the map for the remaining body of the character, generated step 1004. Then, the expanded body segment and the expanded remaining body can be subtracted from each other to find overlapping portions that indicate the edges of the body segment representing the boundary between the body segment and the remaining body of the character.

At step 1008, the animation application 130 computes the angle of a bone associated with the body segment based on joints associated with the body segment. The bone can be imagined to connect an upper joint associated with the body segment with a parent joint of the upper joint.

At step 1010, the animation application 130 applies a directional blur along the edges determined at step 1006 in a direction of the angle of the bone computed at step 1008 to generate a blur map.

At step 1012, the animation application 130 normalizes the blur map and adds the map for the body segment to the blur map to generate a weight map for the body segment. In some embodiments, the animation application 130 normalizes the blur map to, e.g., 0-1, and adds the map for the isolated body segment to the blur map to generate a weight map for the body segment. In some embodiments, values in the weight map that are outside of 0-1 can be clamped to 0 and 1.

At step 1014, if there are additional body segments, then the method 700 returns to step 1002, where the animation application 130 selects another body segment to process. On the other hand, if there are no additional body segments, then the method 700 continues to step 710.

In sum, techniques are disclosed for generating animations of characters and other objects. In some embodiments, an animation application receives user input defining an object, such as a character, and generates, via a diffusion model, images of the object. The animation application then generates a textured geometry of the object by applying the images to planar mesh geometry, such as a square mesh, that includes vertices that can be deformed during animation. Alternatively, the animation application can generate the textured geometry of the character by projecting the images onto 3D geometry that is generated from the images using an image-to-3D reconstruction model. Then, the animation application can use a pose detection model and/or a pose estimation model to determine joints of the object in at least one of the images, or that the object is a non-humanoid object that does not have joints. The animation application further generates a segmentation of the object based on at least one of the images and a watershed segmentation technique if the object is humanoid, or a primary axis of the object and a predefined number of segments if the object is non-humanoid. For a humanoid object, the animation application smears segments in the segmentation of the object against each other along directions where joints associated with the segments connect to generate a smeared segmentation of the object. For a non-humanoid object, the animation application smears segments in the segmentation of the object against each other along directions where joints associated with the segments connect to generate a smeared segmentation of the object. In addition, the animation application can generate a skeleton by connecting the determined joints, if any. Thereafter, the animation application can generate an animation of the object based on the textured geometry, the generated skeleton or a predefined skeleton for non-humanoid objects, the smeared segmentation, and an animation file that specifies an animation of how the object moves and/or deforms.

At least one technical advantage of the disclosed techniques relative to the prior art is that, with the disclosed techniques, animations of objects (e.g., characters) having any shapes and proportions can be generated automatically. Further, the disclosed techniques permit the animations of objects to be generated relatively quickly, including under a few seconds. In addition, the disclosed techniques generate animatable assets that can be puppeteered to produce different animations. These technical advantages represent one or more technological improvements over prior art approaches.

Any and all combinations of any of the claim elements recited in any of the claims and/or any elements described in this application, in any fashion, fall within the contemplated scope of the present invention and protection.
1. In some embodiments, a computer-implemented method for generating animations comprises generating one or more images of an object based on user input, generating textured geometry based on the one or more images, generating a weight map based on at least one image included in the one or more images, and generating an animation of the object based on the textured geometry, the weight map, and a skeleton.
2. The computer-implemented method of clause 1, further comprising determining one or more joint positions based on the at least one image, and generating the skeleton based on the one or more joint positions.
3. The computer-implemented method of clauses 1 or 2, wherein generating the one or more images comprises processing the user input via a trained machine learning model to generate the one or more images.
4. The computer-implemented method of any of clauses 1-3, wherein the trained machine learning model is configured to generate the one or more images based on at least one of a predefined style embedding or a predefined pose.
5. The computer-implemented method of any of clauses 1-4, wherein generating the weight map comprises processing the at least one image via a trained machine learning model to determine a pose of the object, generating a segmentation of the object based on the pose of the object, and performing one or more blurring operations across one or more edges of one or more segments included in the segmentation to generate the weight map.
6. The computer-implemented method of any of clauses 1-5, wherein performing the one or more blurring operations comprises determining the one or more edges of the one or more segments, and computing, for each segment included in the one or more segments, a corresponding direction based on a plurality of joints associated with the segment.
7. The computer-implemented method of any of clauses 1-6, wherein generating the weight map comprises determining a longest axis associated with the object in the at least one image, segmenting the object into a plurality of segments along the longest axis, and performing one or more blurring operations across one or more edges of the plurality of segments to generate the weight map.
8. The computer-implemented method of any of clauses 1-7, wherein the user input comprises text describing at least one aspect of the object.
9. The computer-implemented method of any of clauses 1-8, wherein generating the textured geometry comprises projecting the one or more images onto either planar mesh geometry or three-dimensional (3D) geometry that is generated via a trained machine learning model based on the one or more images.
10. The computer-implemented method of any of clauses 1-9, wherein the object is a character.
11. In some embodiments, one or more non-transitory computer-readable storage media include instructions that, when executed by at least one processor, cause the at least one processor to perform steps for generating animations, the steps comprising generating one or more images of an object based on user input, generating textured geometry based on the one or more images, generating a weight map based on at least one image included in the one or more images, and generating an animation of the object based on the textured geometry, the weight map, and a skeleton.
12. The one or more non-transitory computer-readable storage media of clause 11, wherein the instructions, when executed by the at least one processor, further cause the at least one processor to perform the steps of determining one or more joint positions based on the at least one image, and generating the skeleton based on the one or more joint positions.
13. The one or more non-transitory computer-readable storage media of clauses 11 or 12, wherein generating the one or more images comprises processing the user input via a trained machine learning model to generate the one or more images.
14. The one or more non-transitory computer-readable storage media of any of clauses 11-13, wherein generating the weight map comprises processing the at least one image via a trained machine learning model to determine a pose of the object, generating a segmentation of the object based on the pose of the object, and performing one or more blurring operations across one or more edges of one or more segments included in the segmentation to generate the weight map.
15. The one or more non-transitory computer-readable storage media of any of clauses 11-14, wherein generating the segmentation comprises determining a longest axis associated with the object in the at least one image, and segmenting the object into a plurality of segments along the longest axis.
16. The one or more non-transitory computer-readable storage media of any of clauses 11-15, wherein generating the animation comprises storing data associated with the segmentation as texture data, loading the texture data onto a graphics processing unit (GPU), and computing vertex data based on the texture data.
17. The one or more non-transitory computer-readable storage media of any of clauses 11-16, wherein the one or more images include an image of a back of the object and an image of a front of the object.
18. The one or more non-transitory computer-readable storage media of any of clauses 11-17, wherein generating the textured geometry comprises projecting the one or more images onto either planar mesh geometry or three-dimensional (3D) geometry that is generated via a trained machine learning model based on the one or more images.
19. The one or more non-transitory computer-readable storage media of any of clauses 11-18, wherein generating the one or more images comprises generating one or more prompts based on the user input, and inputting the one or more prompts into a trained diffusion model that generates the one or more images.
20. In some embodiments, a system comprises one or more memories storing instructions, and one or more processors that are coupled to the one or more memories and, when executing the instructions, are configured to generate one or more images of an object based on user input, generate textured geometry based on the one or more images, generate a weight map based on at least one image included in the one or more images, and generate an animation of the object based on the textured geometry, the weight map, and a skeleton.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating animations, the method comprising:
generating one or more images of an object based on user input;
generating textured geometry based on the one or more images;
generating a weight map based on at least one image included in the one or more images; and
generating an animation of the object based on the textured geometry, the weight map, and a skeleton.

2. The computer-implemented method of claim 1, further comprising:
determining one or more joint positions based on the at least one image; and
generating the skeleton based on the one or more joint positions.

3. The computer-implemented method of claim 1, wherein generating the one or more images comprises processing the user input via a trained machine learning model to generate the one or more images.

4. The computer-implemented method of claim 3, wherein the trained machine learning model is configured to generate the one or more images based on at least one of a predefined style embedding or a predefined pose.

5. The computer-implemented method of claim 1, wherein generating the weight map comprises:
processing the at least one image via a trained machine learning model to determine a pose of the object;
generating a segmentation of the object based on the pose of the object; and
performing one or more blurring operations across one or more edges of one or more segments included in the segmentation to generate the weight map.

6. The computer-implemented method of claim 5, wherein performing the one or more blurring operations comprises:
determining the one or more edges of the one or more segments; and
computing, for each segment included in the one or more segments, a corresponding direction based on a plurality of joints associated with the segment.

7. The computer-implemented method of claim 1, wherein generating the weight map comprises:
determining a longest axis associated with the object in the at least one image;
segmenting the object into a plurality of segments along the longest axis; and
performing one or more blurring operations across one or more edges of the plurality of segments to generate the weight map.

8. The computer-implemented method of claim 1, wherein the user input comprises text describing at least one aspect of the object.

9. The computer-implemented method of claim 1, wherein generating the textured geometry comprises projecting the one or more images onto either planar mesh geometry or three-dimensional (3D) geometry that is generated via a trained machine learning model based on the one or more images.

10. The computer-implemented method of claim 1, wherein the object is a character.

11. One or more non-transitory computer-readable storage media including instructions that, when executed by at least one processor, cause the at least one processor to perform steps for generating animations, the steps comprising:
generating one or more images of an object based on user input;
generating textured geometry based on the one or more images;
generating a weight map based on at least one image included in the one or more images; and
generating an animation of the object based on the textured geometry, the weight map, and a skeleton.

12. The one or more non-transitory computer-readable storage media of claim 11, wherein the instructions, when executed by the at least one processor, further cause the at least one processor to perform the steps of:
determining one or more joint positions based on the at least one image; and
generating the skeleton based on the one or more joint positions.

13. The one or more non-transitory computer-readable storage media of claim 11,
wherein generating the one or more images comprises processing the user input via a trained machine learning model to generate the one or more images.

14. The one or more non-transitory computer-readable storage media of claim 11, wherein generating the weight map comprises:
processing the at least one image via a trained machine learning model to determine a pose of the object;
generating a segmentation of the object based on the pose of the object; and
performing one or more blurring operations across one or more edges of one or more segments included in the segmentation to generate the weight map.

15. The one or more non-transitory computer-readable storage media of claim 14, wherein generating the segmentation comprises:
determining a longest axis associated with the object in the at least one image; and
segmenting the object into a plurality of segments along the longest axis.

16. The one or more non-transitory computer-readable storage media of claim 14, wherein generating the animation comprises:
storing data associated with the segmentation as texture data;
loading the texture data onto a graphics processing unit (GPU); and
computing vertex data based on the texture data.

17. The one or more non-transitory computer-readable storage media of claim 11, wherein the one or more images include an image of a back of the object and an image of a front of the object.

18. The one or more non-transitory computer-readable storage media of claim 11, wherein generating the textured geometry comprises projecting the one or more images onto either planar mesh geometry or three-dimensional (3D) geometry that is generated via a trained machine learning model based on the one or more images.

19. The one or more non-transitory computer-readable storage media of claim 11, wherein generating the one or more images comprises:
generating one or more prompts based on the user input; and
inputting the one or more prompts into a trained diffusion model that generates the one or more images.

20. A system, comprising:
one or more memories storing instructions; and
one or more processors that are coupled to the one or more memories and, when executing the instructions, are configured to:
generate one or more images of an object based on user input,
generate textured geometry based on the one or more images,
generate a weight map based on at least one image included in the one or more images, and
generate an animation of the object based on the textured geometry, the weight map, and a skeleton.
